(19) United States
(12) Patent Application Publication
(10) Pub. No.: US 2003/0190887 A1
(43) Pub. Date: Oct. 9, 2003

(54) System and method for wireless multimedia communication

(76) Inventors: Arne Hook, Espoo (FI); Akos Nemeth-Buhin, Espoo (FI); Paul Wattenberger, Wellesley, MA (US); John Ellenberger, Groton, MA (US); Keary Griffin, Waltham, MA (US); Timo Vitikainen, Espoo (FI); Elias Zaretsky, Norwood, MA (US)

Correspondence Address: BANNER & WITCOFF, 1001 G STREET N W, SUITE 1100, WASHINGTON, DC, 20001, US

(21) Appl. No.: 09/949,205

(22) Filed: Sep. 14, 2001

(51) Int. Cl. H04H 1/00; H04N 7/173; H04L 1/18; G08C 25/02

(52) U.S. Cl. 455/3.05; 714/748

(57) ABSTRACT

A system and method are disclosed for transmitting multimedia files to wireless terminal devices, where a multimedia message service center receives one or more multimedia files via a wireless link and initiates a corresponding transmittal of the multimedia files to a selected wireless terminal device. When transmission failure occurs, each multimedia file is stored in a multimedia gateway memory, and the selected wireless terminal device is notified as to a memory identifier for the stored multimedia file. The selected wireless terminal can retrieve the stored multimedia file by providing the memory identifier to the multimedia gateway via the Internet, or to a wireless application protocol server via a multimedia terminal device.

### FIELD OF THE INVENTION

This invention relates to wireless communication systems and, in particular, to a communication method providing multimedia messaging services.

### BACKGROUND OF THE INVENTION

Wireless communication is becoming more widespread as a continually-increasing number of users acquire and place into operation ever greater numbers of wireless terminal devices. Conventional non-multimedia wireless terminal devices are usually designed to display to the user only short messages containing a small amount of text. Newer wireless multimedia terminal devices have additional capability to access and transmit multimedia files, such as graphics files, video files, or sound clip files. For example, a digital image file can be acquired by one multimedia terminal device, viewed by the user, and subsequently transmitted to another multimedia terminal device for viewing by another user. As multimedia terminal devices become more commonplace, it has become apparent that the proliferation of such multimedia devices has resulted in new communication problems.

A problem of incompatibility results when, for example, a multimedia terminal is used to attempt transmittal of a multimedia file to a conventional, non-multimedia wireless terminal device. Since, at most, only a short text message can be received by and displayed in the non-multimedia terminal device, the multimedia files associated with the transmittal are not accessible by and are effectively lost to the user of the conventional non-multimedia device.

Another problem arises as the user of a multimedia terminal device routinely sends and receives large numbers of multimedia files. Because the multimedia terminal device has a finite memory storage capacity, there is a limit as to the number of image and audio files which can be retained in the device. When the available remaining memory of the multimedia terminal device has been depleted, for example, the user is faced with deciding between deleting a stored multimedia file or losing a newly-received multimedia file.

What is needed is a system and method which provide compatibility in transmitting and storing multimedia files when using multimedia and non-multimedia wireless terminal devices.

### SUMMARY OF THE INVENTION

The present invention provides a system and method for transmitting multimedia files to wireless terminal devices. The multimedia files are received at a multimedia message service center via a wireless link, and the multimedia message service center initiates a corresponding transmittal of one or more multimedia files to a called wireless terminal device. When transmission failure is detected, the multimedia files are stored in a multimedia gateway memory, and the selected wireless terminal device is notified as to a corresponding memory identifier. The selected wireless terminal can retrieve the stored multimedia files by providing the memory identifier to the multimedia gateway via the Internet, or to a wireless application protocol server via a multimedia terminal device.

### BRIEF DESCRIPTION OF THE DRAWINGS

The invention description below refers to the accompanying drawings, of which:

FIG. 1 is a diagrammatical representation of a conventional wireless communication system including short message terminal devices and multimedia terminal devices;

FIG. 2 is a diagrammatical representation of a wireless communication system with a multimedia gateway providing for transmission of multimedia files to users of short message terminal devices;

FIG. 3 is a functional block diagram of the multimedia gateway of FIG. 2;

FIG. 4 is a flow diagram illustrating initial steps in the transmission of multimedia files in the system of FIG. 2;

FIG. 5 is a flow diagram illustrating receipt of a multimedia file by a multimedia terminal device;

FIG. 6 is a flow diagram illustrating retrieval of stored multimedia files by wireless terminal devices;

FIG. 7 is a flow diagram illustrating the transferring of one or more multimedia files from a multimedia terminal device to a personal multimedia album in the multimedia gateway of FIG. 2;

FIG. 8 is an alternative embodiment of the wireless communication system of FIG. 2; and

FIG. 9 is a flow diagram illustrating operation of the wireless communication system of FIG. 7.

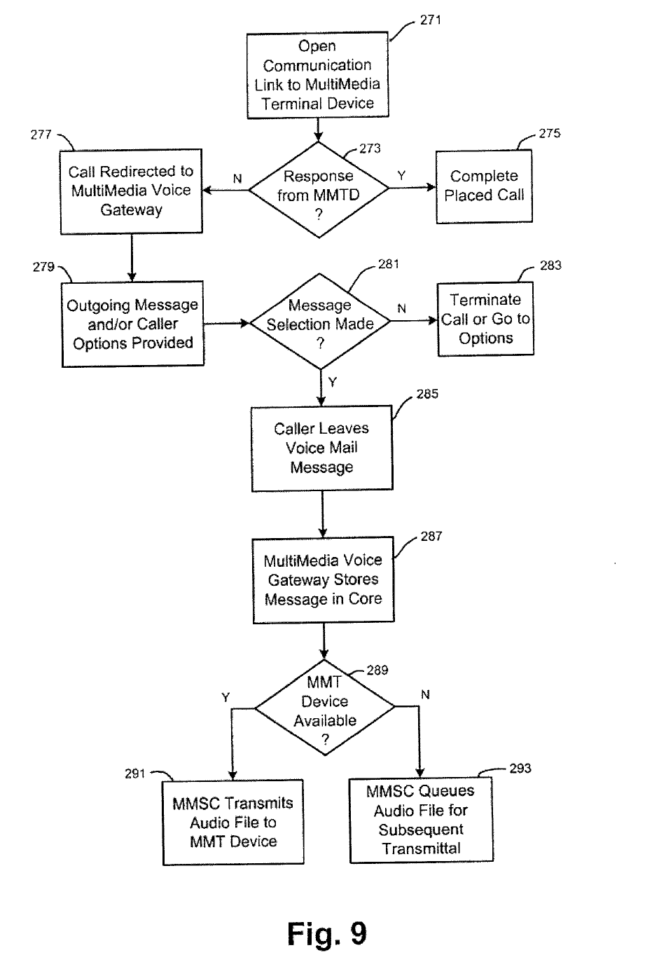

### DETAILED DESCRIPTION OF AN ILLUSTRATIVE EMBODIMENT

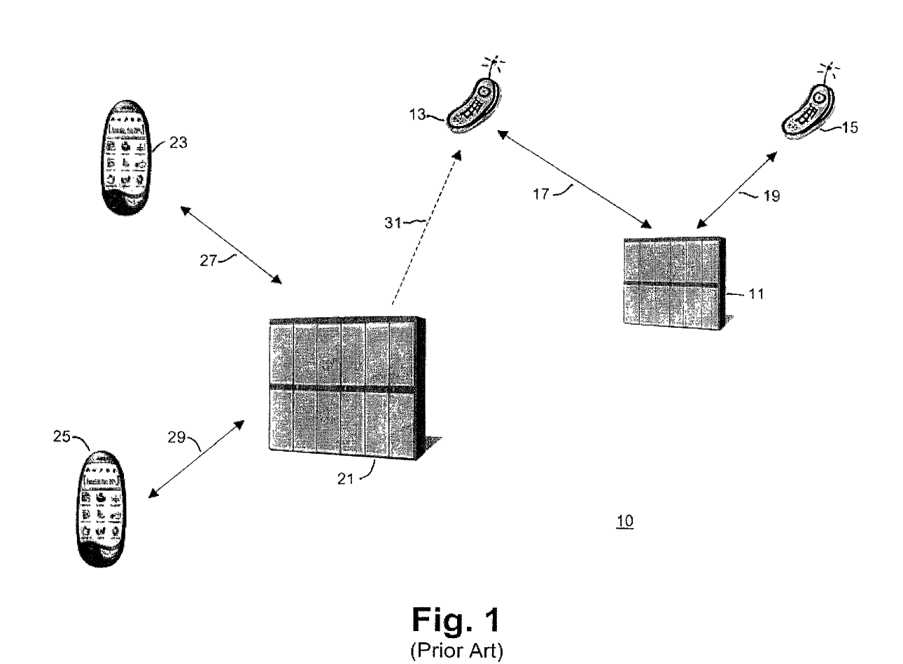

There is shown in FIG. 1 a simplified diagram of a wireless communication system 10 according to the present state of the art. During typical operation, a first short message terminal device 13 can establish a short message communication session with a second short message terminal device 15 via a short message service center 11. As understood by one skilled in the relevant art, a short message terminal device supports a short messaging service. Accordingly, terminal devices 13 and 15 have the capability to send and receive short text messages. The short message communication session is maintained through the short message service center 11 via a first wireless link 17 with the terminal device 13 and via a second wireless link 19 with the terminal device 15. With this configuration, the terminal device 13 can successfully transmit a short text message to the terminal device 15.

Similarly, a first multimedia terminal device 23 can establish a multimedia communication session with a second multimedia terminal device 25 via a multimedia message service center 21, where the multimedia terminal device 23 establishes a first wireless link 27 with the multimedia message service center 21, and the multimedia terminal device 25 establishes a second wireless link 29 as shown. As understood by one skilled in the relevant art, a multimedia message terminal device supports a multimedia messaging service. Accordingly, multimedia terminal devices 23 and 25 have the capability to send and receive multimedia messages, including sound clips, image and video files, and long text messages. In this configuration, multimedia files can be transmitted between the multimedia terminal device 23 and the multimedia terminal device 25.

As explained above, transmission incompatibility arises when a multimedia communication device, such as the multimedia terminal device 23, attempts to send a multimedia file to a non-multimedia communication device, such as the short message terminal device 13. In this scenario, the multimedia message service center 21 is not able to relay the multimedia file to the short message terminal device 13, as indicated by an incomplete transmission arrow 31. Accordingly, the multimedia message is effectively unavailable to the user of the short message terminal device 13 and will typically be deleted as a consequence of the transmission failure.

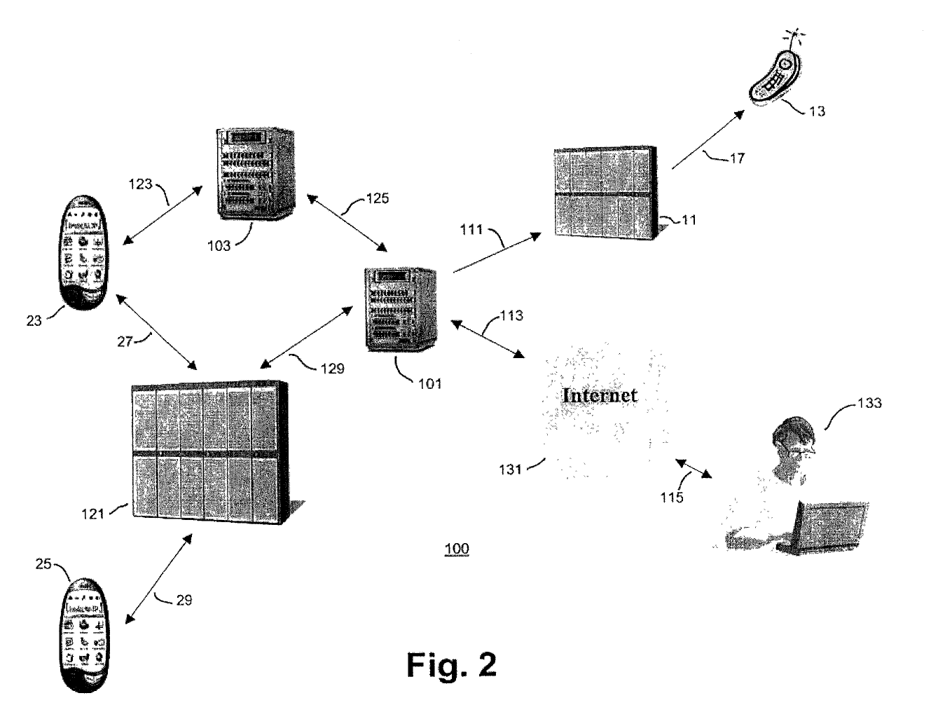

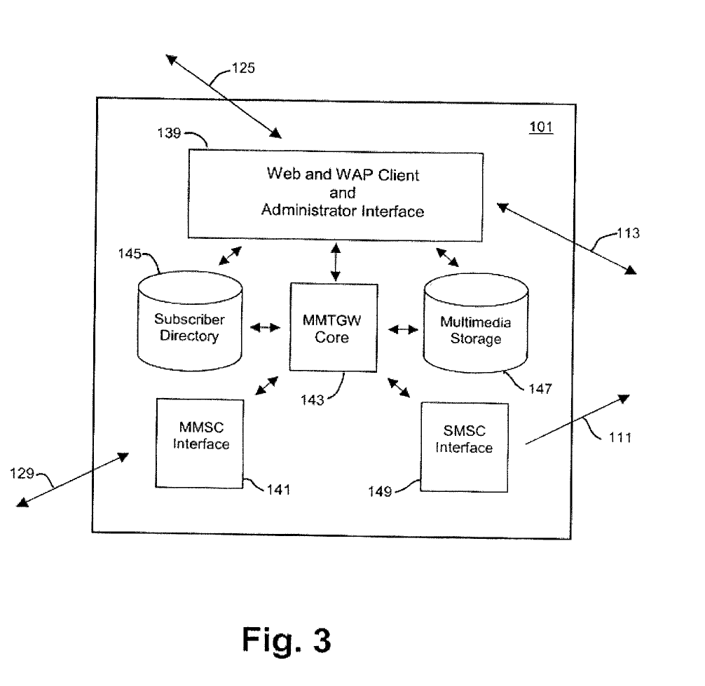

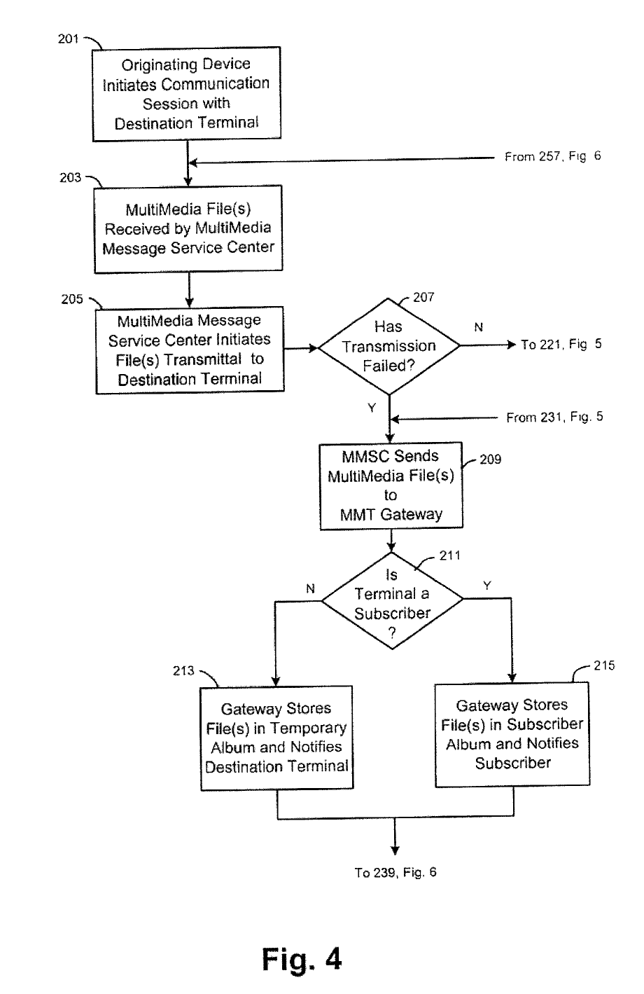

There is shown in FIG. 2 an embodiment of a wireless communication system 100 which overcomes the limitations of the conventional wireless communication system 10, above. The wireless communication system 100 includes a multimedia terminal gateway 101, shown in greater detail in FIG. 3, which functions as an interface between multimedia message service centers and the short message service centers. The method of operation of the wireless communication system 100 and the multimedia terminal gateway 101 can be described with additional reference to the flow diagram of FIG. 4 in which an originating or sending device, such as the multimedia terminal device 23, attempts to initiate a multimedia communication session with a called, or destination, terminal, such as the short message terminal device 13 or the multimedia terminal device 25, at step 201.

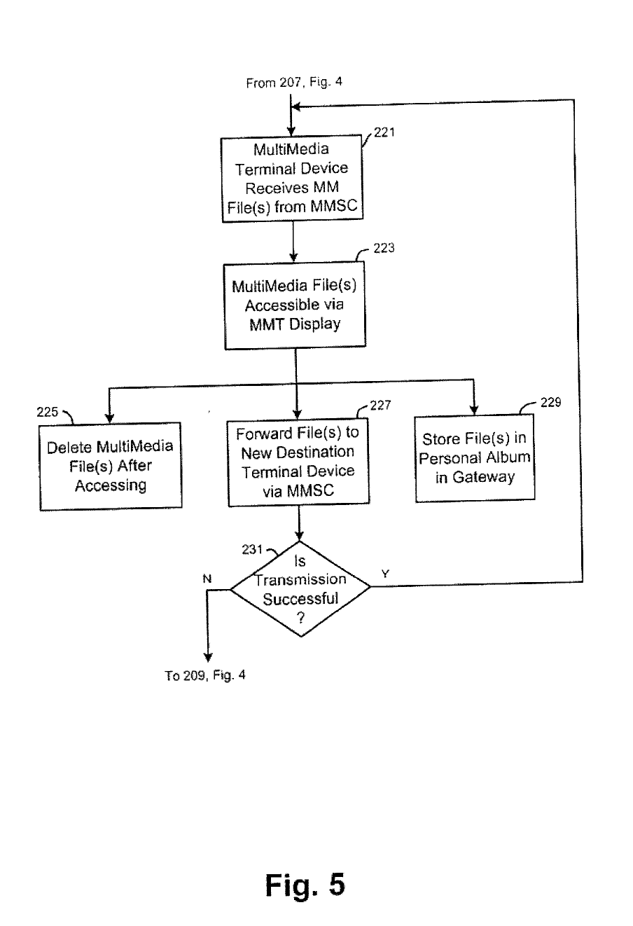

A multimedia message service center (MMSC) 121 receives the multimedia file sent by the multimedia terminal device 23, at step 203, and initiates a file transmittal to the destination terminal device, at step 205. File transmittal is initiated by the multimedia message service center 121 with the sending of a specially-formatted short message to the destination terminal device, as is well-known in the relevant art. If the destination terminal device is a non-multimedia device, such as the short message terminal device 13 for example, the short message sent by the multimedia message service center 121 will be rejected, resulting in a transmission failure at decision block 207. If the destination terminal device is a multimedia device, such as the multimedia terminal device 25 for example, and is not available for receiving the multimedia file, transmission failure occurs and the multimedia file is likewise sent to the multimedia terminal gateway 101. Whenever transmission failure occurs, the multimedia message service center 121 is configured to send the multimedia file to the multimedia terminal gateway 101 via a link 129 to an MMSC interface 141, at step 209. On the other hand, if the destination terminal device is a multimedia terminal device and is also available for receiving messages, the short message sent by the multimedia message service center 121 will be accepted and the multimedia file can be transmitted to the multimedia terminal device, at step 221 in FIG. 5.

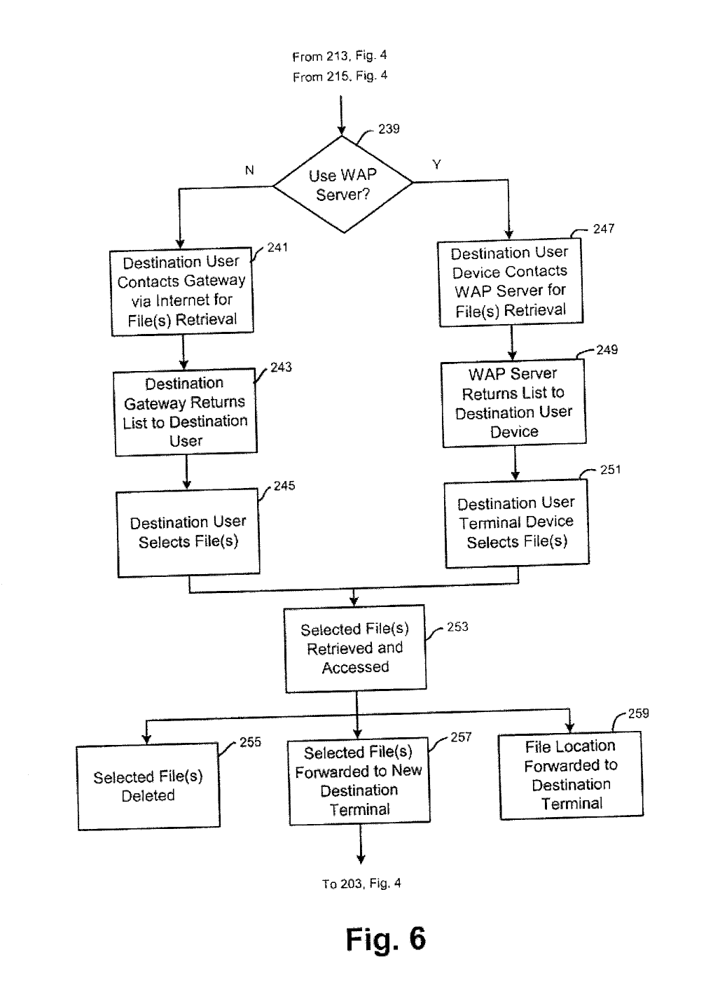

At decision block 211, a gateway core 143 accesses a subscriber directory 145 to determine if the user of the destination terminal device is listed as a subscriber. If the destination terminal device is not listed in the subscriber directory 145, the gateway core 143 places the multimedia file into a temporary ‘multimedia album’ in a multimedia storage 147, at step 213. The gateway core 143 subsequently sends a storage message notifying the destination terminal device providing the location of the stored multimedia file. The indicating location can be a uniform resource locator (URL) address, for example, or some other memory identifier as is well-known in the relevant art. The storage message can be sent to a multimedia terminal device via the MMSC interface 141 and link 129, or to a non-multimedia terminal device via an SMSC interface and a link 111. Alternatively, if the destination terminal device is listed in the subscriber directory 145, such as the multimedia terminal device 25 for example, the gateway core 143 places the multimedia file into a previously-configured personal file or ‘subscriber's album’ in the multimedia storage 147, at step 215, and sends a message notifying the user of the multimedia terminal device 25 of the placement of the stored multimedia file into the subscriber's multimedia album. In any case, the user of the destination terminal device can subsequently access the stored multimedia file, at decision block 239 in FIG. 6.

If transmission to the destination terminal device is successful, at step 207, the multimedia file received by the destination terminal device, at step 221 in FIG. 5, can be accessed using a files listing provided on the display of the destination terminal device, at step 223. The user of the destination terminal device thus has the option of deleting selected files, at step 225, or alternatively, the user can select files for forwarding to another destination terminal device, at step 227.

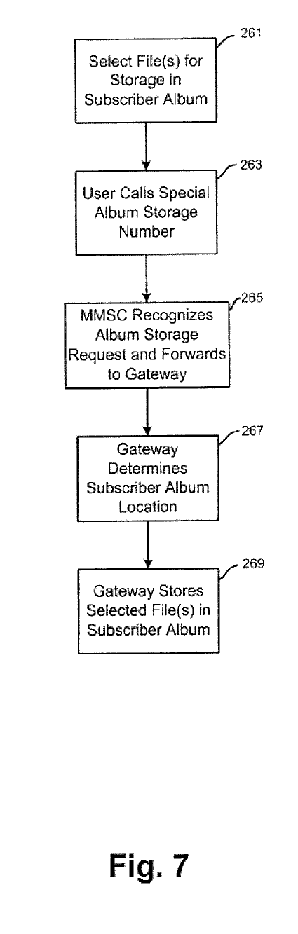

Another option available to the subscriber is to store selected files in the subscriber multimedia album in the multimedia storage 147, at step 229, for example, or at step 261 in FIG. 7. This can be done to retain or free up memory resources in the multimedia terminal device 25. It can further be appreciated by one skilled in the relevant art that the user of the personal multimedia terminal device 23 may also have a multimedia album in the multimedia storage 147.

If the user elects to forward selected files to another user of the wireless communication system 100, a determination is first made at decision block 231 in FIG. 5 as to whether the intended transmission was successful. If a successful transmission is established, operation proceeds to step 221. When a failed transmission occurs at decision block 231, indicating that the new destination terminal device is a short message terminal device or that a connection cannot otherwise be established, operation proceeds to step 209 in FIG. 4.

After the user of the destination terminal device has retrieved the text message sent by the multimedia terminal gateway 101 at step 213 or 215 in FIG. 4, the multimedia terminal gateway 101 can subsequently be contacted to retrieve stored files. A choice is made, at decision block 239 in FIG. 6, as to whether a stored file is to be accessed using the Internet or using wireless protocol. To retrieve the stored files via the Internet, the user of the destination terminal device communicates with the multimedia terminal gateway 101 from a workstation or personal computer 133, shown in FIG. 2, and may be prompted to provide a password for access to user files. An Internet connection to the multimedia terminal gateway 101 can be provided by communication links 113 and 115 establishing a path to the personal computer 133 from a web and WAP client and administrator interface 139 in FIG. 3. When contacted by an authorized user, at step 241 in FIG. 6, the multimedia terminal gateway 101 returns a list of stored user multimedia files to the personal computer 133, at step 243. One or more of the listed files can be selected, at step 245, for access and retrieval, at step 253.

Alternatively, for access to the multimedia files following receipt of the notification message sent by the multimedia terminal gateway 101 at steps 213 or 215 in FIG. 4, a wireless application protocol (WAP) server 103 in FIG. 2 can be contacted for the retrieval of files via a communication link 125, at step 247 in FIG. 6. The WAP server 103 returns a list of multimedia files to the destination terminal device, at step 249. One or more of the listed files can be selected at the destination terminal device, at step 251, and the selected files can subsequently be retrieved for access by the user, at step 253. A selected multimedia file can be deleted, at step 255, forwarded to a new destination terminal device, at step 257, or the location of the one or more files can be forwarded to the new destination terminal device, at step 259. If the selected files are forwarded, operation continues at step 203 in FIG. 4.

When the subscriber elects to store selected files in the subscriber multimedia album in the multimedia storage 147, as in step 229 above, the process followed can be described with reference to the flow diagram of FIG. 7 in which selected files stored in the user multimedia terminal device are identified for storage in the subscriber's personal multimedia album, at step 261. The user contacts the multimedia message service center 121 using a special calling number, at step 263. The multimedia message service center 121 recognizes the incoming call as a request to access the subscriber's personal album, at step 265, and contacts the multimedia terminal gateway 101. The multimedia terminal gateway 101 identifies the subscriber from the user's multimedia terminal device and determines the location of the subscriber's personal multimedia album in the multimedia storage 147, at step 267. The files selected for storage by the user are then stored in the subscriber's personal multimedia album, at step 269. To subsequently retrieve a stored multimedia file from a subscriber's personal multimedia album, the subscriber proceeds to step 239 above.

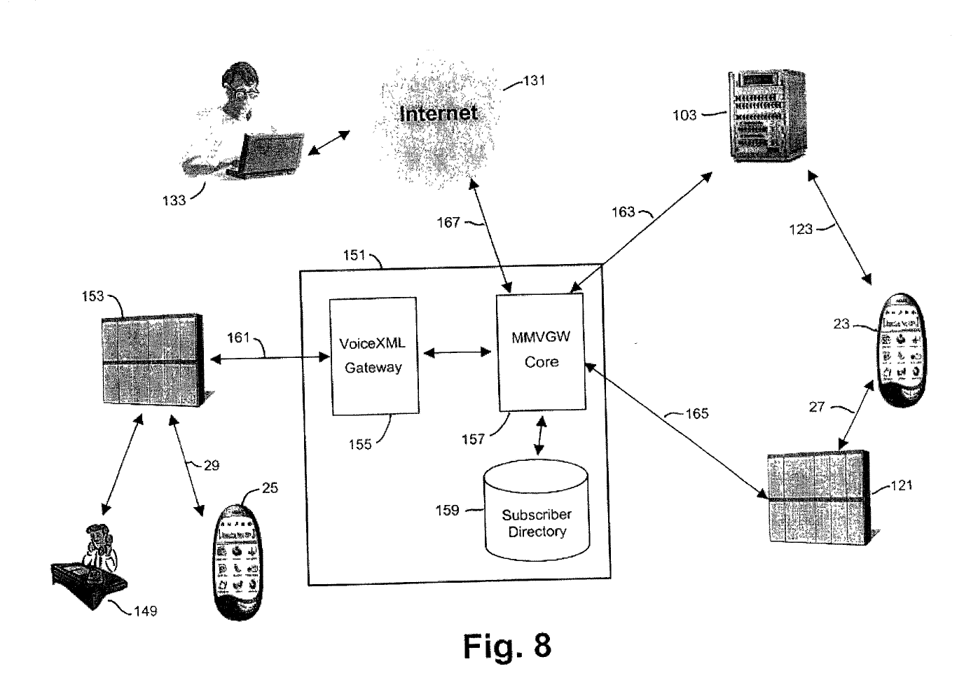

In an alternative embodiment, shown in FIG. 7, a caller can access the multimedia terminal device 25 or a conventional desktop phone 149 to initiate a conventional telephone call with a user at the multimedia terminal device 23, at step 271 of FIG. 8. The transmission is handled by a mobile switching center 153 which functions to provide connection to the multimedia terminal device 23 when a call is completed, at step 275. If the multimedia terminal device 23 does not respond because the called user does not answer or is not reachable, at decision block 273, the transmission is redirected to a multimedia voice gateway 151, preferably over an SS7 or voice-over-IP (VoIP) link 161, at step 277. The link 161 is handled by a speech browser or a VoiceXML gateway 155 in the multimedia voice gateway 151. As is well-known in the relevant art, VoiceXML, which is an extension to the Extensible Markup Language (XML), provides a common language for scripting voice-based computer interactions. VoiceXML thus provides some standardization when a speech application is developed for use in telephony-based speech recognition systems, for example.

The voice XML gateway 155 executes a script received from a multimedia voice gateway core 157, preferably over HTTP, where the script may play a greeting or take a message, at step 279. These selections are provided to the caller, at decision block 281. The caller may terminate the call or select other options, at step 283. If the caller decides to leave a voice message, at step 285, the VoiceXML gateway 151 passes the audio message to the multimedia voice gateway core 157 for storage, at step 287. Preferably, the audio message includes caller identification and a time stamp for convenience in returning the call.

The multimedia voice gateway core 157 references a subscriber directory 159 to determine how to process the script or to decide which greeting to play. The subscriber directory 159 contains information about users listed as accessing the multimedia voice gateway 151 for voice mail services.

At the earliest opportunity, the multimedia voice gateway 151 sends the stored audio message to the multimedia terminal device 23 through the multimedia message service center 121 via a link 165 using an external Application interface protocol over HTTP. At decision block 289, the multimedia message service center 121 sends the audio message to the multimedia terminal 23 via the link 27 if the multimedia terminal 23 is accessible, at step 291, or queues the audio message if the multimedia terminal 23 is not reachable, at step 293. As a result, the user of the multimedia terminal 23 can directly retrieve and listen to the audio message without first needing to access a conventional voice mail system. Moreover, since the audio message is stored as a voice clip, the user can forward the audio message to other users as desired.

An Internet link 167 from the multimedia voice gateway 151 is used by a user at the personal computer 133 for access to the client configuration, as an alternative to the access by the wireless application protocol server 103. The Internet link 167 can also be used for an administrator client for configuration or operation of the multimedia voice gateway 151.

While the invention has been described with reference to particular embodiments, it will be understood that the present invention is by no means limited to the particular constructions and methods herein disclosed and/or shown in the drawings, but also comprises any modifications or equivalents within the scope of the claims.

What is claimed is:

1. A method for transmitting a multimedia file to a user of a wireless terminal device, said method comprising the steps of:
receiving the multimedia file at a multimedia message service center via a wireless link;
initiating a transmission to the wireless terminal device in response to said step of receiving said multimedia file;
detecting a failed transmission in response to said step of initiating said transmission;
sending the multimedia file to a multimedia terminal gateway in response to said step of detecting said failed transmission; and
retrieving the multimedia file from said multimedia terminal gateway in response to a request by the user of the wireless terminal device.

2. The method of claim 1 further comprising the step of providing a memory identifier to the user of the wireless terminal, said memory identifier locating the multimedia file in said multimedia gateway.

3. The method of claim 2 wherein said step of retrieving the multimedia file from said multimedia gateway comprises the step of providing said memory identifier to said multimedia gateway.

4. The method of claim 3 wherein said step of providing said memory identifier to said multimedia gateway comprises the step of accessing said multimedia gateway via the Internet.

5. The method of claim 3 wherein said step of providing said memory identifier to said multimedia gateway comprises the step of accessing said multimedia gateway via a wireless application protocol server.

6. The method of claim 1 further comprising the step of transmitting the multimedia file to said multimedia message service center from a multimedia terminal device.

7. The method of claim 1 wherein the multimedia file comprises a member of the group consisting of a graphics file, a video file, and a sound clip file.

8. A method for transmitting an audio file to a wireless terminal device, said method comprising the steps of:
receiving an audio message from a caller;
storing the audio file using a speech browser gateway; and
if said wireless terminal device is available, transmitting said audio file to the wireless terminal device or, if said wireless terminal device is not available, queueing said audio file for subsequent transmittal to the wireless terminal device.
